(19) United States
(12) Patent Application Publication
(10) Pub. No.: US 2001/0005362 A1
(43) Pub. Date: Jun. 28, 2001

(54) Handling of certain messages in a telecommunication system

(76) Inventor: Haim Guata, Raanana (IL)

Correspondence Address: NATH AND ASSOCIATES, 1030 FIFTEEN STREET, 6TH FLOOR, WASHINGTON, DC, 20005, US

(21) Appl. No.: 09/734,768

(22) Filed: Dec. 13, 2000

(30) Foreign Application Priority Data
Dec. 14, 1999 (IL) 133504

(51) Int. Cl. H04J 1/16

(52) U.S. Cl. 370/244; 370/250

(57) ABSTRACT

A device operative in a digital communication system and adapted to receive digital signals and transmit them along a transmission path, characterized in that this device is capable of preventing the transmission of a message comprising a pre-defined sequence of signals that is indicative of a malfunction occurred at the transmission path.

### FIELD OF THE INVENTION

The present invention relates to telecommunications systems in general and in particular to the handling of certain types of messages in telecommunication systems.

### BACKGROUND OF THE INVENTION

Telecommunications has moved in the recent years towards digital networks carrying voice, facsimile and other signals. One known way in the art to increase the efficiency of such networks is to transmit the signals in a compressed form, thus using the available bandwidth for simultaneous transmission of more information.

Bandwidth constrains have been a significant issues and in particularly for international links, whether they are satellite or cable, where speech compression in the form of digital circuit multiplication equipment (DCME), Media Gateways and the like, is employed. Consequently, a drive for using speech coding technology was established. This technology allows more efficient use of the transmission medium, which in turn results in lower tariffs.

Another area where speech coding plays a vital role is the multimedia services, where the reduced data rate required for the transmission of the audio component maximizes the bandwidth available to the visual component.

The situation today is that a number of speech coding techniques have already been adopted as international standards for various network applications, whereas others are used as proprietary algorithms. For many new network developments such as global virtual private networks, mobile, cellular satellite and even the asynchronous transfer mode (ATM) network, it is no longer a question whether to use speech compression, but which speech coding technology provides the required speech quality and bandwidth efficiency at best price.

International Telecommunication Union (ITU) Recommendation G.711 standardized in 1972 the 64 Kbit/s (Kbps) PCM coding method that provides toll-quality speech transmission.

At a later stage this technique was improved when incorporated with Digital Speech Interpolation (DSI) technique that suppresses the silent periods between the spoken words and syllables using reliable silence elimination and regeneration procedures at both the transmitting and receiving terminals. Consequently, when a speaker is silent, the transmission channel is made available to other active in progress. At the receiving end of the link, relatively non-disturbing noise is usually substituted during the periods of connectionless.

At a later stage, a further compression of bandwidth required for the transmission of calls was achieved by implementing ADPCM speech coding technique which allowed a compression gain of up to 5:1 for speech transmission.

An ITU 16 kbps speech coder, known as the G.728 Low Delay Code Exited Linear Predictive (LD-CELP) coder, was standardized in 1992. This method, which is generally based on the replacement of 64 Kbit/s voice signals by pre-defined digital codes, allows speech compression gain of as high as 9:1.

The compression algorithm known as CS-ACELP was approved as ITU-T Recommendation No. G.729. This algorithm provides a further compression gain, allowing the compression of the 64 Kbit/s PCM voice signals, into 8 Kbit/s coded signals.

Many of these advanced algorithms are based on coding models such as CELP coding model, where the voice input is converted to corresponding pre-defined codebook vectors by the system's compressing device (encoder) and are transmitted in their converted form along the transmission path (the bearer) towards the corresponding decompressing device (decoder).

The transmission received at the decoder end is comprised of codebook vectors and is converted back to the original audio signals, as illustrated in FIG. 1.

When the transmitting end of the system encounters various performance malfunctions, different alarms such as AIS, LOS, or others are generated. Naturally, such alarms which are essentially transmissions each comprising a pre-defined message are transmitted along the transmission path to the network elements connected along the path.

Following a detection of an alram state by a network element, this element may notify the local switch of the new condition by e.g. by injecting the appropriate network alarm. In such a case, the switch should block the traffic from being assigned to this malfunctioning path.

However, when a bearer alarm is generated, the compression network element receives a series of bits, all having the value of 1 (“All 1's” bits, which will be referred to hereinafter as “AIS”).

In packetized networks, e.g. IP networks, ATM networks, etc. a similar situation may occur. When a problem arises along the bearer, e.g. failure of a router, the payload of the packets transmitted along the transmission path will comprise a certain pre-defined message which is indicative of the failure that occurred. In packetized networks these “deformed” packets serve in a way similar to the alram described above for TDM type of systems.

It was now surprisingly found that certain messages that are generated in response to a failure occurring along the transmission path, will still be regarded by the element receiving them as legitimate messages comprising regular data that should be processed as any other data comprising message.

As an example, let us consider a case where a codebook vector of “All 1's” is generated and received by a decoder. The decoder will consider this vector to be a valid vector and will then convert the vector's value into the corresponding audio signal. The output of a voice decoder in this case is a loud tone with a high amplitude to which the subscriber is exposed and which is completely unacceptable for a human listner.

### SUMMARY OF THE INVENTION

It is therefore an object of the present invention to provide a digital telecommunication station capable of overcoming the above-described prior art problems.

It is another object of the present invention to provide a digital communication system which prevents transmitting certain pre-defined messages to the receiving end of the system.

Yet another object of the present invention is to provide a method for efficient handling an alarm situation in a telecommunication network.

Further objects and features of the invention will become apparent to those skilled in the art, from the following description and the accompanying drawings.

In accordance with a first embodiment of the present invention there is provided a device operative in a digital communication system and adapted to receive digital signals and transmit them along a transmission path, characterized in that it is capable of preventing the transmission of a message comprising a pre-defined sequence of signals that are indicative of a malfunction that occurred at the transmission path.

One example of such type of message is “All 1's” (referred to herein as “AIS”) alarm message, which is essentially a bit stream, wherein each one of the bits has the value of 1. The term “message” as used throughout the specification in connection with the present invention is used to denote a message that comprises a sequence of signals e.g. a transmission in a TDM network, as well as to denote a frame and/or a packet comprising a pre-defined series of signals generated as a result of a malfunction that occurred along the transmission path.

The term “pre-defined” as used herein, should be understood to encompass any sequence of signals will be generated every time a certain malfunction occurs in any such network. It also encompasses any such sequence that is specific to a particular network but is reproducoble for that network. In other words, every time the specific malfunction occurs in that network, a message comprising the same sequence (pattern) of signals is generated so that the device of the present invention can be provided at one stage or another with the suitable information to allow the detection of such a message.

In accordance with another embodiment of the present invention there is provided a device adapted to receive coded digital signals and decode them into their decoded digital output signals, characterized in that when receiving a bit stream of at least a first number of consecutive bits each having the value of 1, is capable of preventing the transmission of said bit stream further along the transmission path.

According to another preferred embodiment of the invention the coded digital signals received are selected from the group consisting of voice signals, fax signals, data signals, voiceband data signals and video signals. More preferably, the decoding device is adapted to receive voice signals.

According to another preferred embodiment of the present invention, where such an “AIS” message is to be transmitted towards the receiving end of the network, the transmission will be prevented provided that the number of consecutive bits each having the value of 1, is at least about 10. More preferably, if a series of at least from about 20 bits to about 40 bits, each having the value of 1 is detected, the bit stream will not be transmitted to the receiving end of the network.

In accordance with yet another embodiment of the present invention there is provided a device adapted to receive digital signals in a packetized form, characterized in that when a pre-defined combination of signals is present in a packet received, the device is capable of preventing the transmission of said packet further along the transmission path, e.g. by discarding such a packet.

According to another embodiment of the present invention there is provided a digital telecommunication station adapted to operate in a digital communication system, and comprising:

at least one receiving means adapted to receive digital signals;

at least one controller adapted to receive a group of digital signals and determine whether said group comprises a message comprising a pre-defined pattern;

at least one routing means controlled by said at least one controller and adapted to allow transmission of the digital signals, provided that said group of digital signals does not comprise said message comprising the pre-defined pattern; and

at least one transmitting means adapted to receive signals from said routing means and transmit them.

The term “group of signals” is used to denote a bit stream in a TDM type of system, as well as a packet and/or a frame in a packetized system.

According to yet another embodiment of the present invention there is provided a digital telecommunication station adapted to operate in a digital communication system, and comprising:

at least one pair of compressing/decompressing devices each adapted to encode/decode digital signals received;

at least one controller adapted to receive a bit stream of encoded digital signals and determine whether said bit stream comprises at least a first number of consecutive bits each having the value of 1;

at least one router controlled by said at least one controller and adapted to allow transmission of the digital signals in their decoded form, provided that said bit stream does not comprise at least a first number of consecutive bits each having the value of 1.

The term “router” as used herein, should be understood also to encompass any type of a switch that is operative to carry out switching functions but has no capability of routing the transmissions received thereby.

According to still another embodiment of the present invention there is provided a digital communication system, comprising:

transmission means at least a first end of a transmission network for transmitting digital signals;

receiving means at at least a second end of the transmission network;

a transmission path connecting said transmitting means with said receiving means; and

at least one controlling means operative along said transmission path and adapted to prevent receipt of a transmission of an alarm message having a pre-defined pattern, by said receiving means.

In accordance with still another embodiment of the 20 invention there is provided a digital communication system for interconnecting a plurality of telecommunication trunks via a transmission path, comprising:

first transmission means at least a first end of the transmission network adapted for transmitting digital signals;

at least one pair of telecommunication stations of the type described above; and

receiving means at at least a second end of the transmission network.

The term “telecommunication network” as will be used hereinafter, should be understood to encompass the various types of networks known in the art, such as TDM, synchronous and asynchronous transfer networks, IP networks, IP frame relaying networks and any other applicable packet communication networks,

As previously explained, the term “telecommunication station” is used herein to describe a combination of at least two compressing/decompressing devices, one of which is used for compressing signals when required, while the other is used as its corresponding de-compressor (e.g. one such device may be an encoder while the other a decoder, etc.). These two devices may be included within one apparatus or be separated from each other.

According to another preferred embodiment of the present invention the transmission path is a digital bearer and may be comprised of fiberoptic links, digital microwave, satellite routes, and the like.

As was previously explained, some of the embodiments of the present invention are related to various types of telecommunication systems wherein signals are transmitted in their coded form, where the coding is done in accordance with pre-defined codes, used by both the encoder and the decoder, and wherein a message of a pre-defined pattern, e.g. a series of “1”s (AIS), can be interpreted by the decoding device as a legitimate code that should be decoded. Examples of such pre-defined codes are LD-CELP, CS-ACELP, E-CELP, A-CELP, Q-CELP, VCELP and others that comply with the above.

According to yet another embodiment of the present invention there is provided a method for use in a digital communication system which method comprises:

(i) receiving digital signals transmitted along a transmission path;

(ii) determining whether the digital signals received comprise a pre-defined pattern that is characteristic of a message generated as a result of a malfunction occurring in said digital communication system;

(iii) transmitting the digital signals as long as no such a pre-defined pattern is detected; and

(iv) preventing the transmission of digital signals along the transmission path in the event that said pre-defined pattern was detected.

According to yet another embodiment of the present invention there is provided a method for use in a digital communication system which method comprises:

(i) receiving encoded digital signals transmitted along a transmission path;

(ii) determining whether the encoded digital signals received comprise a sequence of pre-defined number of consecutive bits each having the value of 1;

(iii) decoding the encoded digital signals as long as no such a sequence is detected; and

(iv) preventing the transmission of decoded digital signals along the transmission path in the event that a sequence of pre-defined number of consecutive bits each having the value of 1 was detected.

As could be appreciated by a person skilled in the art, step (iv) may be carried out according to either one of the following two main options. The one is to allow the pre-defined number of “1” bits to be processed by the decoder, thus allowing any code that is comprised of “1” bits but has fewer bits than the pre-defined threshold, to be decoded. Once this threshold is exceeded, no further consecutive bits having the value of “1” will be decoded and transmitted. The other option, is, creating a delay in the system, so that the bits are stored temporary in a buffer, and prior to their decoding and transmission to determine whether they comprise at least one sequence of signals having the combination that is equivalent to at least one of the pre-defined combinations, which detection is used to prevent the transmission of that message.

According to another preferred embodiment of the invention, the method further comprises the step of:

(v) resuming the transmission of digital signals along said transmission path following the removal of the cause for initiating said pre-defined pattern of signals.

According to yet another embodiment of the present invention there is provided a method for use in a digital communication system which method comprises:

(i) transmitting a message comprising a sequence of characters identifying the operative transmitting means, the type of signals to be transmitted and their destination;

(ii) establishing a communication link between a first transmitting means and a receiving means at the transmission destination;

(iii) exchanging signals between a pair of telecommunication stations operative along the transmission path, identifying for each one the existence of the other and the rate for transmitting signals therebetween;

(iv) transmitting information signals in their encoded form at the rate defined along a transmission path;

(v) receiving encoded digital signals transmitted along a transmission path;

(vi) determining whether the encoded digital signals received comprise a pre-defined pattern that is reserved for an alarm message in said digital communication system;

(vii) decoding the encoded digital signals as long as no such a pre-defined pattern is detected;

(viii) preventing the transmission of decoded digital signals along the transmission path following the event that said pre-defined pattern was detected.

According to another preferred embodiment of the invention the method further comprises the steps of:

(ix) awaiting for the cause for initiating said alarm message is removed; and

(x) resuming transmission of decoded digital signals along said transmission path.

### BRIEF DESCRIPTION OF THE DRAWINGS

FIG. 1 illustrates a communication network comprising two telecommunication stations;

FIG. 2 describes schematically a set-up wherein an “All 1's” bit streams reaches the telecommunication station; and

FIG. 3 presents an example of telecommunication station operative in accordance with the present invention.

### DETAILED DESCRIPTION OF THE INVENTION

In the modern communication traffic network, a large number of communicating channels may simultaneously occupy the full bandwidth available. Examples of such applications may be found in concurrent transmissions of voice channel(s) with or without compression, fax video, data or any combination thereof. Due to the cost of bandwidth in international and some domestic routes, compression equipment is used for reducing the bandwidth costs.

To achieve this goal, various products such as DCME, transcoders, Voice-Over-IP gateways and other products have been employed to compress the traffic transmitted over various routes. Typically, the higher compression rates that are achievable today are achieved by using various coding algorithms such as those of the CELP group of algorithms.

Let us now turn to the Figures. FIG. 1 illustrates an example where a voice call is to be transmitted from transmitting means 1 to receiving means 2. As may be seen in this figure a pair of telecommunication stations (5 and 7) is operating along the transmission path defined (9). The call generated at transmitting means 1, may be transmitted via an exchange (not shown in this figure) until being encoded in encoder 13 of station 5. From encoder 13 the compressed signals are transmitted along bearer 9 to decoder 15 of station 7. In this decoder, the compressed signals are decoded essentially to their original non-compressed digital form, and routed to receiving end 3.

When the reverse direction is applied, i.e. a transmission is carried from 3 to 1, the transmitted signals are encoded in station 7 by encoder 17 and the call according to the present example will be routed along transmission path 11 to station 5, where the compressed signals will be decoded by decoder 19. Therefrom, the decoded signals will be transmitted to the receiving end 1.

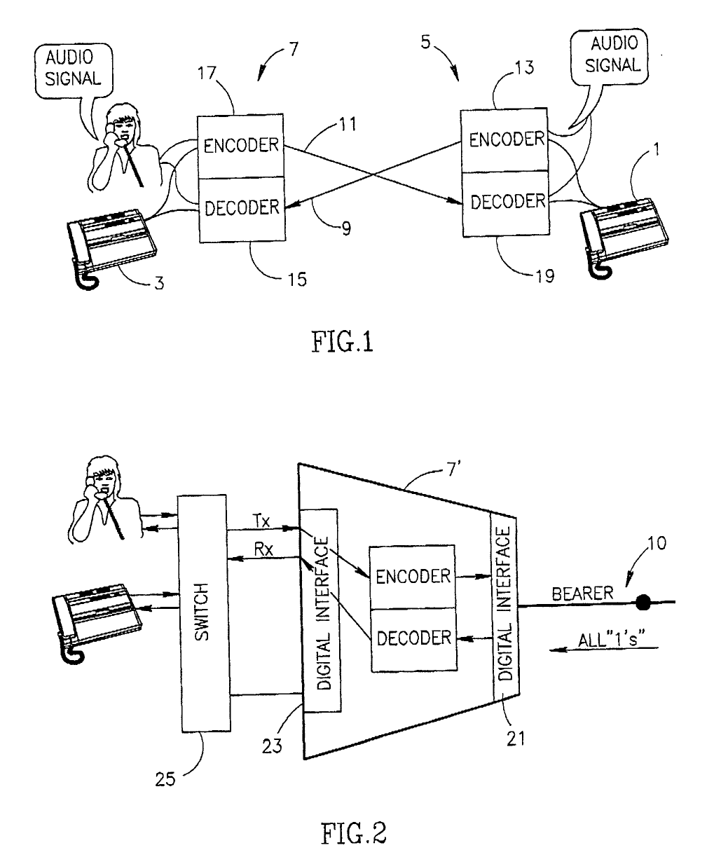

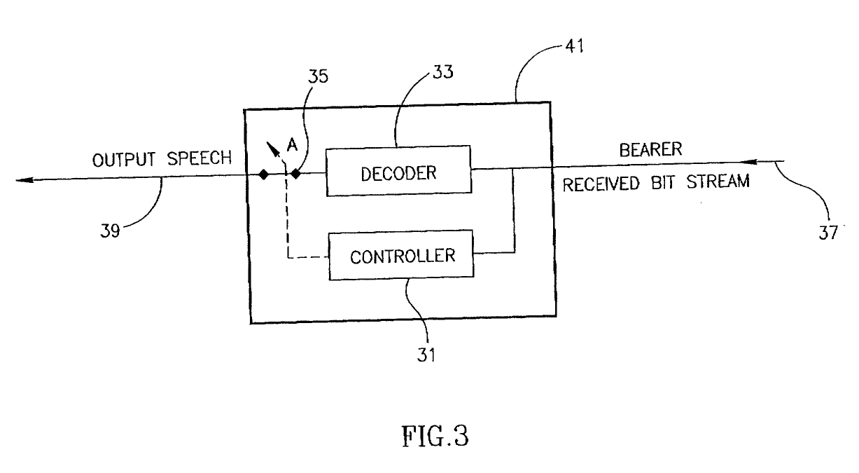

FIG. 2 presents a schematic partial view of station 7 and its environment illustrated in FIG. 1, when an alarm situation arises.

In the case that the transmission media 10 S encounters a performance malfunction an alarm such as AIS, LOS (Loss Of Signal) etc., is initiated and transmitted to the network elements which are operatively connected to the transmission media. As previously explained, the alarm message comprises a series of consecutive bits, all having the value of 1. In the present example, the alarm message received in station's 7′ digital interface 21 through which bearer 10 is connected to station 7′. The alarm state is detected by station 7 controller (not shown in this figure) and notifies the local switch 25 of the new condition. Consequently, switch 25 should block all traffic from being assigned to bearer 10.

FIG. 3 illustrates an example of a part of compressing/decompressing station that is suitable to overcome the loud tone that would otherwise be generated when the decoder decompressed that series of 1's thus received, in an attempt to decode a legitimate code in transmitted in the network.

By this example, a controller 31 is installed in parallel to decoder 33, and controls the operation of a normally closed switch 35. As long as the controller does not detect a bit stream of at least a 40 consecutive bits each having the value of 1, received from bearer 37, the encoded bits received via the bearer are decoded in decoder 33 and transmitted in their essentially decompressed form via transmission path 39. However, when an alarm state is detected by controller 31, i.e. when the threshold of 40 consecutive bits of 1's detected is exceeded, the controller causes switch 35 to switch to open mode, thus preventing the decoded bit stream from being transmitted along path 39. In the present example, the controller was demonstrated as being included in the same compressing/decompressing telecommunication station as decoder 33. As would be realized by any person skilled in the art, various modifications to such a set-up can be made, e.g. including the controller before or after the compressing/decompressing telecommunication station.

In a packetized network, the prevention of transmission of such a message comprising a pre-defined sequence of signals such as a packet comprising a sequence of “1's”, an empty packet within a frame, and the like, may be carried out by discarding a packet and/or a frame comprising this message. Alternatively, the prevention of transmission of such a message is done by replacing the message with another and forwarding the new packet(frame) comprising the replacing message.

Preferably, the replacement is done by using the contents of other packets or frames, as the case may be, which do not contain such a message. As an example, this can be carried out by taking the contents of a previous packet and the one following that with the message, and replacing the contents of the packet (or frame) with a new packet (frame) which contents is dependent upon these two other packets (frames).

It will be appreciated that the above-described methods may be varied in many ways, including changing the order of steps, and the exact implementation used. It should also be appreciated that the above described description of methods and apparatus are to be interpreted as including apparatus for carrying out the methods and methods of using the apparatus.

The present invention has been described using non-limiting descriptions of preferred embodiments thereof that are provided by way of example and are not intended to limit the scope of the invention. It should be understood that the features described with respect to one embodiment may be used with other embodiments and that not all embodiments of the invention have all of the features exemplified. The above description serves for the illustration of the invention, and any other way of achieving the same end result of preventing the transmission of messages that comprise an indication of a network malfunction, towards the receiving end, may be devised by a person skilled in the art without departing from the scope of the invention, and are thus encompassed by the present invention.

1. A device operative in a digital communication system and adapted to receive digital signals and transmit them along a transmission path, characterized in that said device is capable of preventing the transmission of a message comprising a pre-defined sequence of signals that are indicative of a malfunction occurred at said transmission path.

2. A device according to claim 1, wherein said message is an AIS message.

3. A device according to claim 1, wherein said message is comprised within a payload of a packet in a packetized type of transmission.

4. A device according to claim 1, adapted to receive coded digital signals and decode them into their decoded digital output signals, characterized in that when receiving a bit stream of at least a first number of consecutive bits each having the value of 1, is capable of preventing the transmission of said bit stream further along the transmission path.

5. A device according to claim 4, wherein the coded digital signals received are selected from the group consisting of voice signals, fax signals, data signals, voiceband data signals and video signals.

6. A device according to claim 5, wherein the signals received are voice signals.

7. A device according to claim 6, wherein said first number of consecutive bits each having the value of 1 is at least from about 10 bits.

8. A device according to claim 7, wherein said first number of consecutive bits each having the value of 1 is in the range of from at least about 20 to about 40 bits.

9. A device according to claim 3, wherein the prevention of transmission of said message comprising a pre-defined sequence of signals is done by discarding a packet comprising said message.

10. A device according to claim 3, wherein the prevention of transmission of said message comprising a pre-defined sequence of signals is done by discarding a frame comprising said message.

11. A device according to claim 3, wherein the prevention of transmission of said message comprising a pre-defined sequence of signals is done by discarding a packet comprising said message.

12. A device according to claim 3, wherein the prevention of transmission of said message comprising a pre-defined sequence of signals is done by replacing said message with another message and forwarding a packet comprising the replacing message.

13. A device according to claim 3, wherein the prevention of transmission of said message comprising a pre-defined sequence of signals is done by replacing said message with another message and forwarding a frame comprising the replacing message.

14. A device according to claim 12, wherein the replacing messsage is dependent on the contents of a message preceding the message that comprises said pre-defined sequence of signals and the contents of a message following the message that comprises said pre-defined sequence of signals.

15. A digital telecommunication station adapted to operate in a digital communication system, and comprising:
at least one receiving means adapted to receive digital signals;
at least one controller adapted to receive a group of digital signals and determine whether said group comprises a message comprising a pre-defined pattern;
at least one routing means controlled by said at least one controller and adapted to allow transmission of the digital signals, provided that said group of digital signals does not comprise the message comprising the pre-defined pattern; and
at least one transmitting means adapted to receive signals from said routing means and transmit them.

16. A digital telecommunication station adapted to operate in a digital communication system, and comprising:
at least one pair of compressing/decompressing devices each adapted to encode/decode digital signals received;
at least one controller adapted to receive a bit stream of encoded digital signals and determine whether said bit stream comprises at least a first number of consecutive bits each having the value of 1;
at least one router controlled by said at least one controller and adapted to allow transmission of the digital signals in their decoded form, provided that said bit stream does not comprise at least a first number of consecutive bits each having the value of 1.

17. A digital communication system, comprising:
transmission means at least a first end of a transmission network for transmitting digital signals;
receiving means at at least a second end of the transmission network;
a transmission path connecting said transmitting means with said receiving means; and
at least one controlling means operative along said transmission path and adapted to prevent receipt of a transmission of a message comprising a pre-defined pattern, by said receiving means.

18. A digital communication system for interconnecting a plurality of telecommunication trunks via a transmission path, comprising:
first transmission means at least a first end of the transmission network adapted for transmitting digital signals;
at least one pair of telecommunication stations of claim 16; and
receiving means at at least a second end of the transmission network.

19. A digital telecommunication system according to any one of claims 17, wherein said transmission path comprises a member selected from the group comprising of optical fiber, digital microwave and satellite route.

20. A method for use in a digital communication system which method comprises:
(i) receiving digital signals transmitted along a transmission path;
(ii) determining whether the digital signals received comprise a pre-defined pattern that characterizes a message generated as a result of a malfunction occurringin said digital communication system;
(iii) transmitting the digital signals as long as no such a pre-defined pattern is detected; and
(iv) preventing the transmission of digital signals along the transmission path in the event that said pre-defined pattern is detected.

21. A method for use in a digital communication system comprising:
(i) receiving encoded digital signals transmitted along a transmission path;
(ii) determining whether the encoded digital signals received comprise a sequence of pre-defined number of consecutive bits each having the value of 1;
(iii) decoding the encoded digital signals as long as no such a sequence is detected and forwarding then towards a receiving end of the transmission path; and
(iv) preventing the transmission of decoded digital signals along the transmission path in the event that a sequence of pre-defined number of consecutive bits each having the value of 1 was detected.

22. A method according to any one of claim 21, further comprising:
(v) resuming the transmission of digital signals along said transmission path following the removal of the cause for initiating said pre-defined pattern of signals.

23. A method for use in a digital communication system, which method comprises:
(i) transmitting a message comprising a sequence of characters identifying the operative transmitting means, the type of signals to be transmitted and their destination;
(ii) establishing a communication link between a first transmitting means and a receiving means at the transmission destination;
(iii) exchanging signals between a pair of telecommunication stations operative along the transmission path, identifying for each one the existence of the other and the rate for transmitting signals therebetween;
(iv) transmitting information signals in their encoded form at the rate defined along a transmission path;
(v) receiving encoded digital signals transmitted along a transmission path;
(vi) determining whether the encoded digital signals received comprise a pre-defined pattern that is reserved for an alarm message in said digital communication system;
(vii) decoding the encoded digital signals as long as no such a pre-defined pattern is detected;
(viii) preventing the transmission of decoded digital signals along the transmission path following the event that said pre-defined pattern was detected.

24. A method according to claim 23, further comprising the steps of:
(ix) awaiting for the cause for initiating said alarm message is removed; and
(x) resuming transmission of decoded digital signals along said transmission path,

25. A device according to claim 1, wherein the alarm message is a legitimate code in an algorithm selected from the froup consisting of LD-CELP, CS-ACELP; E-CELP and A-CELP, Q-CELP, VCELP.

26. A digital telecommunication station according to claim 15, wherein the alarm message is a legitimate code in an algorithm selected from the group consisting of LD-CELP, CS-ACELP; E-CELP and A-CELP, Q-CELP, VCELP.

27. A digital communication system according to claim 17, wherein the alarm message is a legitimate code in an algorithm selected from the froup consisting of LD-CELP, CS-ACELP; E-CELP and A-CELP, Q-CELP, VCELP.

28. A method according to claim 20, wherein the alarm message is a legitimate code in an algorithm selected from the froup consisting of LD-CELP, CS-ACELP; E-CELP and A-CELP, Q-CELP, VCELP.
